(19) United States
(12) Patent Application Publication
(10) Pub. No.: US 2009/0185762 A1
(43) Pub. Date: Jul. 23, 2009

(54) DATA STRUCTURE FOR IMAGE FILE

(75) Inventors: Jiang HE, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/016,283

(22) Filed: Jan. 18, 2008

(51) Int. Cl. G06K 9/54

(52) U.S. Cl. 382/305

(57) ABSTRACT

A data structure for an image file includes an image file head, a data area, an index table, and file tail information. The image file head records hardware parameter information of a storage device and partitions the storage device into a plurality of data units. The data units are compressed to generate corresponding compressed data blocks. The generated compressed data blocks are stored in the data area. The index table uses an index value to record start positions of the data units and positions of the compressed data blocks in the image file into the index table. The file tail information marks a file length of the image file. During network transmission of the image file, a destination may restore the received compressed data blocks to the corresponding positions.

### BACKGROUND OF THE INVENTION

1. Field of Invention

The present invention relates to a data structure for recording an image file, and more particularly to an improved data structure for recording an image file.

2. Related Art

Common users may feel troublesome in installing a computer system and application programs thereof because they should be familiar with the settings about peripheral devices and the computer system. Furthermore, each installation will spend a lot of time, and re-installation is needed if any error occurs in the first installation period. In order to save installation time, a method of backing up a computer system has been provided.

The so-called computer system backup is to back up the data in storage devices of a computer system from a source, including system information or application programs. If the computer system suffers any malfunctions or damages in future use, the computer system may be restored to the configuration before the data backup as long as a user restores the backup data into the computer system and it is unnecessary for the user to devote care to setting a computer system and installing application programs. Furthermore, the restoration time is much less than the time spent in the installation of the computer system.

Currently, PC (for example, notebook) manufacturers usually pre-install operating systems such as Microsoft Windows System in PCs before leaving factories. Since such operating systems have a large amount of data and take a lot of time to install, the restoration technology of an image file is often used to perform pre-installation of operating systems and/or other application programs on the PCs in the factories, so as to achieve the object of quick installing an operating system, thereby improving the productive efficiency of product lines.

A conventional method of generating an image file is shown in FIG. 1, which is a schematic view of generating an image file. Read relevant information about storage devices (here referring to a hard disk for installing an operating system and/or application systems) of a source (Step S110), in which the relevant information includes, for example, the quantity of sectors of the storage device, positions of files, and the quantity of the files. Then, perform image file processing according to the relevant information of the storage device (Step S120), so as to compress the files in the storage device according to the relevant information and rearrange the compressed files.

Generally speaking, the conventional method of backing up an image file factually may achieve the backup advantage on the direct backup between the storage devices, for example, restoring the image file from the source to the storage device at a destination by using an optical disk or other different storage media. However, if the transmission from the source to the destination is finished through Internet, the following problems may possibly occur. 1. The image file must be received sequentially from the beginning; and 2. if data is missed in the transmission, the transmission should be performed again, thereby wasting a lot of time.

The main reason lies in the composition of the data structure for the image file. In a common data structure for an image file, operations such as arrangement and compression are performed according to file storage positions in the storage device. In order to recreate an image file, recombination information about the image file is required. For example, the recombination information may be stored in the file head or file tail of the image file. Other destinations cannot restore the data in the image file according to the recombination information until the image file has been received.

In addition, disk storage mechanism provided by operating systems may have different limitations of the storage size of the image file. For example, in the FAT disk storage mechanism provided by Microsoft, FAT-16 limits a single file to be no more than 2 GB, and FAT-32 limits a single file to be no more than 4 GB. If the first storage device of the source has a size larger than the limitation on its storage file, the image file cannot be processed.

### SUMMARY OF THE INVENTION

In view of the aforementioned problem, the present invention is mainly directed to provide a backup system for recording a data structure for an image file.

The data structure for an image file provided by the present invention includes an image file head, a data area, an index table, and file tail information. The image file head records hardware parameter information of a storage device of a source. The data area includes a plurality of compressed data blocks which are stored successively, and the compressed data blocks record the compressed data in a plurality of partitioned data units with a fixed data length in the storage device of the source, respectively. The index table has an index value for recording the start positions of the data units in the storage device of the source and the positions of the compressed data blocks in the data area. The file tail information records a file length of the image file. Each of the compressed data blocks further includes an original data length field, a compressed data block length field, and a check code field. The original data length field is used to record the size of effective data stored in each data unit. The compressed data block length field is used to record the size of the data in the compressed data block. The check code field is used to check the processed record field according to the compressed data block, and the check code field checks whether the compressed data block malfunctions in transmission when the data has been restored.

According to the data structure for an image file provided by the present invention, the image file may be restored in transmission without considering the receiving sequence. During a network transmission period, if the destination has a missed compressed data block, it may firstly restore the data which has been received. Furthermore, in the present invention, the sizes of the data units may be adjusted according to different file storage mechanisms, so that the size of the image file of the present invention may not be limited by the capacity of files such as EXT, NTFS, FAT16, or FAT32.

### BRIEF DESCRIPTION OF THE DRAWINGS

The present invention will become more fully understood from the detailed description given herein below for illustration only, and thus are not limitative of the present invention, and wherein:

FIG. 1 is a schematic view of generating an image file conventionally;

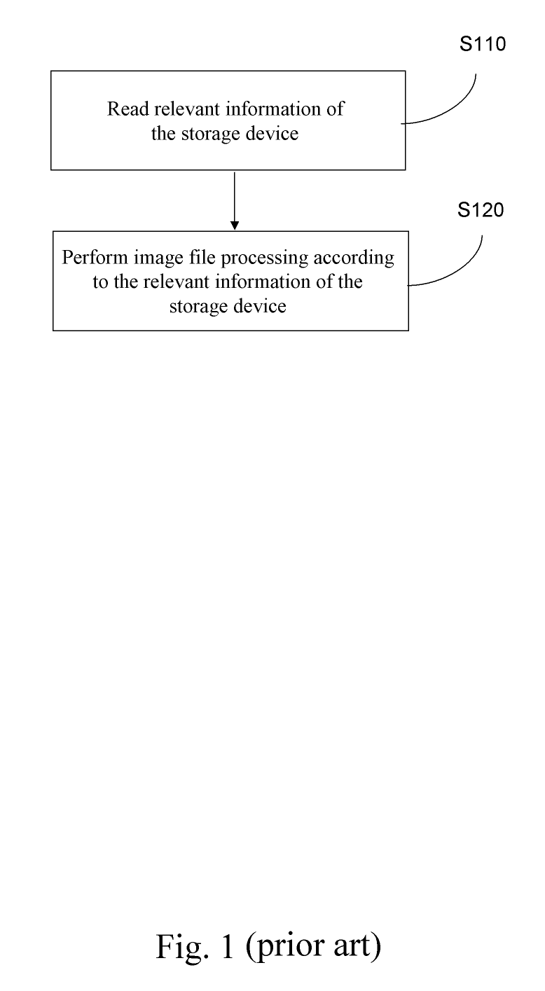

FIG. 2a is a schematic view of the data structure for an image file according to the present invention;

FIG. 2b is a schematic structural view of the compressed data block according to the present invention;

FIG. 2c is a schematic view of the contents in the index table according to the present invention; and

FIG. 3 is a timing graph of the transmission by using the multicasting transmission technology according to the present invention.

### DETAILED DESCRIPTION OF THE INVENTION

The present invention provides a data structure for recording an image file, which is applied to a first storage device in a source. The first storage device is used to store an operating system or relevant application programs. The source may be a PC, a notebook, a tablet PC, or a mobile computing device. The storage device may be a hard disk, a redundant array of independent disks (RAID), a memory card, or a storage device.

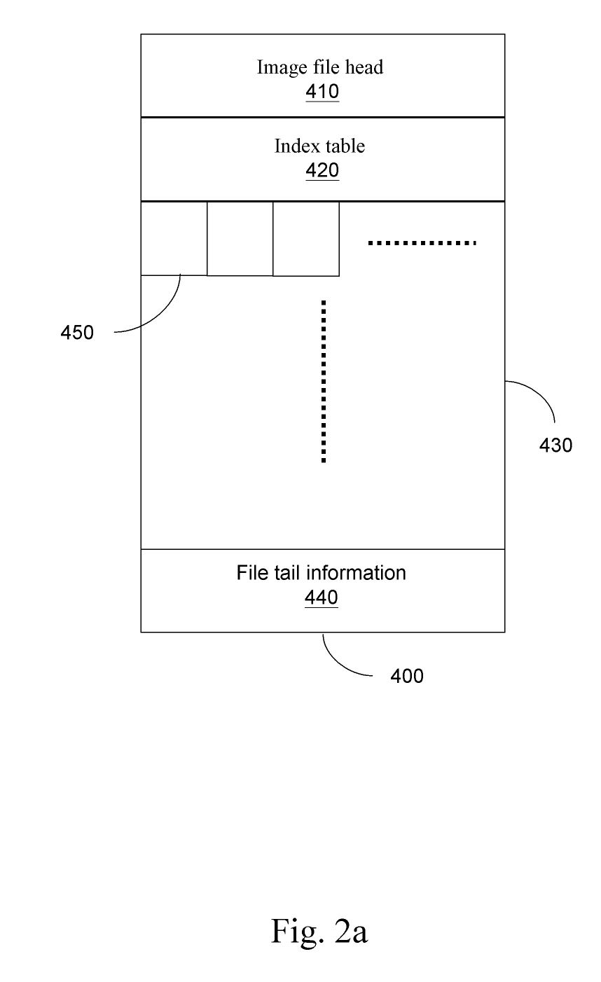

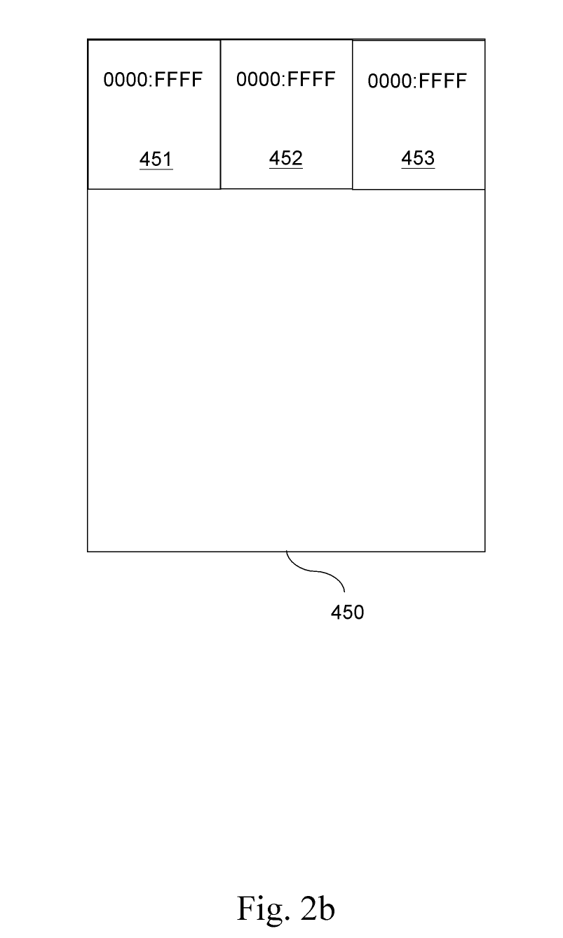

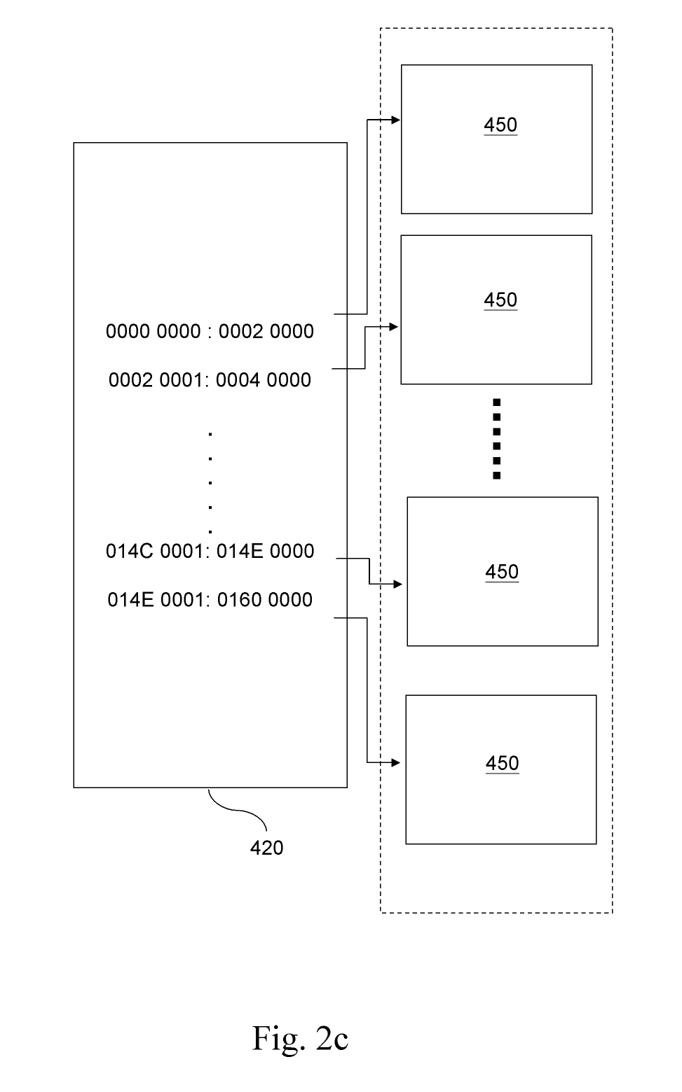

Referring to FIG. 2a, a schematic view of the data structure for an image file according to the present invention is shown. The image file includes an image file head 410, an index table 420, a data area 430, and file tail information 440. The image file head 410 is generated according to hardware parameter information of the first storage device, and if the first storage device is a hard disk, the hardware parameter information includes a head, a cylinder, and a sector.

The data area 430 stores a plurality of compressed data blocks 450 which are stored successively, and the compressed data blocks 450 respectively record compressed data in a plurality of partitioned data units with a fixed data length in the first storage device of the source. In a preferred embodiment of the present invention, the data units are partitioned in the first storage device by a unit of 2 MB. Therefore, a storage device of 20 GB may have 10240 data units, so 10240 compressed data blocks 450 will be generated after the compression step. The size of the data unit depends on a disk storage mechanism to be processed as an image file. For example, in the preferred embodiment of the present invention, each of the data units may store 2 MB of data under an ideal situation.

It should be noted that, the compressed data block 450 further includes an original data length field 451, a compressed data block length field 452, and a check code field 453. Referring to FIG. 2b, a schematic structural view of the compressed data block according to the present invention is shown. The original data length field is used to record the size of effective data stored in each data unit. Please refer to the bit map information in the file systems such as NTFS or Linux EXT for the so-called effective data. Regarding a practical file storage mechanism, the file data is not always stored in successive blocks, with a result that not all data units store 2 MB of data. If the size of the data stored in each data unit is 2 MB, the data field 451 may be recorded in a length of 4 bytes.

The compressed data block length field 452 is used to record the size of the data in the compressed data block 450, and in other words, record the size of the data actually stored in the data units after being compressed. The check code field 453 is used to identify and check the compressed data block 450. The check code is generated by using a cyclic redundancy check (CRC), an MD5 method, or a low-density parity-check (LDPC), so that the data integrity of the compressed data block 450 is verified according to the check code after the image file 400 is restored. The lengths of the compressed data block length field 452 and the check code field 453 are also determined according to the size of the data units, and in this embodiment, the lengths of the fields are respectively recorded by 4 bytes.

The index table 420 includes an index value (not shown), which is used to record the start positions of the data units in the first storage device of the source and the positions of the compressed data blocks 450 in the data area 430. Furthermore, referring to FIG. 2c, a schematic view of the contents in the index table according to the present invention is shown. In FIG. 2c, the index table 420 records the positions of the data units in the disk of the first storage device. The file tail information 440 is generated at the tail of the image file 400, and the file tail information 440 is used to mark the file length of the image file 400, so that the destination may confirm the practical data length of the image file 400 when receiving the image file 400.

The advantages of the data structure for the image file provided by the present invention are more prominent in network transmission, especially for the multicasting transmission technology. The so-called “multicasting” refers to that one host computer may transmit the same data to multiple hosts through a multicasting router at the same time. The multicasting transmission is characterized in that the source in the network may send the same data to every destination at a time, so as to reduce the transmission amount in the network. However, as for the conventional data structure for an image file, when the destination misses one data packet, it has to receive the image file again, resulting in serious waste of the resources in the source and destination. Therefore, in order to meet the features of the multicasting transmission, in the present invention, the first storage device is partitioned into multiple data units, and the destination may confirm the storage position of the compressed data block 450 by referring to the image file head 410 and the index table 420.

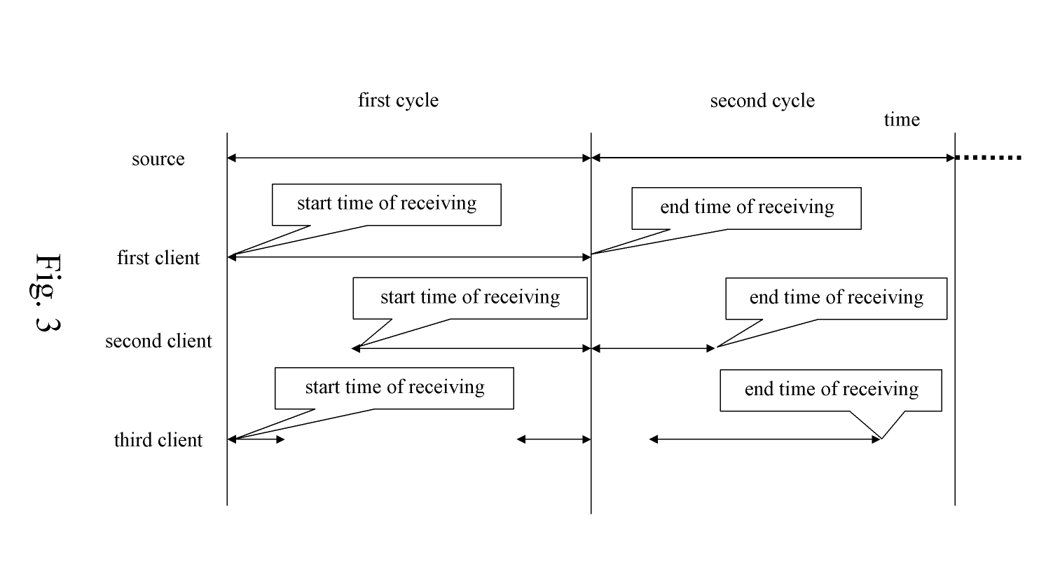

Referring to FIG. 3, a timing graph of the transmission by using the multicasting transmission technology according to the present invention is shown. As shown in the above portion of FIG. 3, the source transmits the time length of the image file 400 by using the multicasting transmission technology. Herein, it is assumed that one cycle of transmission may be performed after each time of transmission, till the source stops transmitting the image file 400. Each of the destinations in FIG. 3 may receive the image file 400 transmitted by the source at different time points. For example, the first destination receives the image file 400 transmitted by the source at the very beginning, and meets no interruption during the transmission. Therefore, after the first cycle, the first destination also has received the image file 400.

A second destination begins to receive the image file 400 in the first cycle. At this time, a second destination may store the currently received data units in the corresponding positions of the second storage device according to the index table 420 of the image file 400. Therefore, the second destination may receive the image file 400 as long as it has received the unreceived data units in the second cycle. A third destination does not receive a portion of the image file 400 beginning and ending at the first cycle in the transmission of the first cycle, so it may firstly arrange the data units that have been received according to the index table 420 and then receive the missed portion of the image file 400 when transmitting the image file 400 in the second cycle, thereby finishing the transmission of the image files 400.

In the present invention, the image file may be restored in transmission without considering the receiving sequence. During a network transmission period, if the destination has a missed compressed data block, it may firstly restore the data which has been received. Furthermore, in the present invention, the sizes of the data units may be adjusted according to different file storage mechanisms, so that the size of the image file of the present invention may not be limited by the capacity of files such as EXT, NTFS, FAT16, or FAT32.

What is claimed is:

1. A data structure for recording an image file, wherein the image file is an image file of data stored in a computer accessible recording equipment and corresponding to a source, the data structure for the image file comprising:
an image file head, for recording hardware parameter information of a storage device of the source;
a data area, having a plurality of compressed data blocks which are stored successively, wherein the compressed data blocks record compressed data in a plurality of partitioned data units with a fixed data length in the storage device of the source, respectively;
an index table, having an index value, wherein the index value is used to record start positions of the data units in the storage device of the source and positions of the compressed data blocks in the data area; and
file tail information, for recording a file length of the image file.

2. The data structure for recording an image file as claimed in claim 1, wherein the fixed length of each of the data units is 2 GB.

3. The data structure for recording an image file as claimed in claim 1, wherein the compressed data block further comprises:
an original data length field, for recording a size of the data stored in the data unit; a compressed data block length field, for recording a size of the data in the compressed data block; and
a check code field, for identifying and checking the compressed data block.

4. The data structure for recording an image file as claimed in claim 3, wherein the check code is generated by using a cyclic redundancy check (CRC).

5. The data structure for recording an image file as claimed in claim 3, wherein the check code is generated by using an MD5.

6. The data structure for recording an image file as claimed in claim 3, wherein the check code is generated by a low-density parity-check code (LDPC).
